(19) United States
(12) Patent Application Publication
(10) Pub. No.: US 2025/0273030 A1
(43) Pub. Date: Aug. 28, 2025

(54) DEVICES FOR GENERATING VOTING RECEIPTS

(71) Applicants: Stephen B. Maguire, West Chester, PA (US); Paul S. Maguire, Thornton, PA (US)

(72) Inventors: Stephen B. Maguire, West Chester, PA (US); Paul S. Maguire, Thornton, PA (US)

(21) Appl. No.: 18/588,241

(22) Filed: Feb. 27, 2024

(51) Int. Cl. G07C 13/00

(52) U.S. Cl. CPC G07C 13/00

(57) ABSTRACT

A device for generating a voting receipt is provided for use in a voting system. The voting system also includes an electronic voting machine configured to record the voting choices of a voter. The device communicates with the electronic voting machine via a local area network only, and receives from the electronic voting machine data indicating the voting choices of the voter. The device prints a voting receipt that indicates the voting choices of the voter. The voting receipt is a permanent record by which the voter can verify that their votes have been accurately recorded by the electronic voting machine.

### BACKGROUND

The integrity of public elections has been, and continues to be a controversial topic in the United States and elsewhere. The confidence of voters that their votes have been accurately recorded is critical to functioning democracies where the choice of political leaders and important public issues are resolved through voting by the citizenry. The issue of voter confidence can be especially problematic in jurisdictions that use electronic voting machines in which the voter's choices are converted into an electronic format that the voter cannot review to verify that voter's choices have been registered accurately.

### SUMMARY

In one aspect of the disclosed technology, a device for generating a voting receipt is configured for use with a voting system having an electronic voting machine configured to record voting choices of a voter. The device includes a control unit configured to be communicatively coupled to the electronic voting machine via a local area network only, and to receive from the electronic voting machine data indicating the voting choices of the voter. The device also includes a printing unit communicatively coupled to the control unit and configured to print the voting receipt. The voting receipt indicates the voting choices of the voter.

In another aspect of the disclosed technology, the voting receipt further incudes a time stamp indicating the time and date on which the voting choices of the voter were recorded by the electronic voting machine.

In another aspect of the disclosed technology, the control unit is configured to be communicatively coupled to the electronic voting machine via an encrypted communication link.

In another aspect of the disclosed technology, the control unit includes a memory, and the control unit is further configured to store in the memory the data indicating the voting choices of the voter.

In another aspect of the disclosed technology, the control unit is further configured to download the data indicating the voting choices of the voter to a device configured to receive the data indicating the voting choices of the voter.

In another aspect of the disclosed technology, the control unit is further configured to communicate only with the electronic voting machine and the device configured to receive the data indicating the voting choices of the voter.

In another aspect of the disclosed technology, the control unit is further configured to receive inputs only from the electronic voting machine and the device configured to receive the data indicating the voting choices of the voter.

In another aspect of the disclosed technology, the local area network includes the voting-device, the electronic voting machine, and the device configured to receive the data indicating the voting choices of the voter.

In another aspect of the disclosed technology, the control unit is further configured so that a running time and date upon which the time stamp is based cannot be altered by an outside source.

In another aspect of the disclosed technology, the control unit is further configured so that the data indicating the voting choices of the voter cannot be altered or deleted from the memory by an outside source.

In another aspect of the disclosed technology, the control unit includes the memory, a processor communicatively coupled to the memory, and computer-executable instructions stored on the memory and configured to, upon execution by the processor, cause the printing unit to generate the voting receipt.

In another aspect of the disclosed technology, the computer-executable instructions are open-source software.

In another aspect of the disclosed technology, a voting system includes an electronic voting machine configured to record voting choices of a voter, and a device for generating a voting receipt. The device includes a control unit communicatively coupled to the electronic voting machine via a local area network only, and configured to receive from the electronic voting machine data indicating the voting choices of the voter. The device also includes a printing unit communicatively coupled to the control unit and configured to generate the voting receipt. The voting receipt indicates the voting choices of the voter.

In another aspect of the disclosed technology, the electronic voting machine is one of an optical scanner and a direct recording electronic machine.

In another aspect of the disclosed technology, the electronic voting machine and the device for generating voting receipts are provided by different manufacturers.

In another aspect of the disclosed technology, the electronic voting machine is configured to generate an output indicting the voting choices of the voter, and the device for generating a voting receipt is configured to generate the voting receipt upon receiving the output of the electronic voting machine.

In another aspect of the disclosed technology, the printout further incudes a time stamp indicating the time and date on which the voting choices of the voter were recorded by the electronic voting machine.

In another aspect of the disclosed technology, the device for generating a voting receipt is communicatively coupled to the electronic voting machine via an encrypted communication link.

In another aspect of the disclosed technology, the printing unit is configured to generate the voting receipt on a real-time or near real-time basis with the recordation of the voting choices of the voter by the electronic voting machine.

In another aspect of the disclosed technology, the control unit is further configured to download the data indicating the voting choices of the voter to a device configured to receive the data indicating the voting choices of the voter, and the control unit is further configured to communicate only with the electronic voting machine and the device configured to receive the data indicating the voting choices of the voter.

In another aspect of the disclosed technology, a process for verifying voting totals includes providing an electronic voting machine configured to record voting choices of a voter, and providing a device configured to generate a receipt indicating the voting choices of the voter as cast on the electronic voting machine, and further configured to store data indicating the voting choices of the voter as cast on the voting machine, the device being physically and functionally independent of the electronic voting machine. The process also includes providing the receipt to the user, and publishing the data indicating the voting choices of the voter as stored in the device in a medium accessible to the voter.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a diagrammatic illustration of a voting system that includes a device for generating voting receipts;

FIG. 2 is a schematic illustration of the receipt-generating device shown in FIG. 1; and

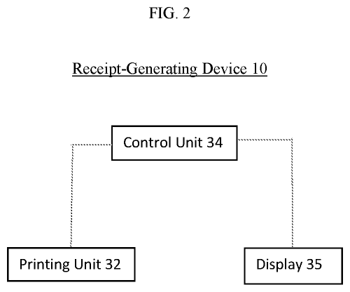

FIG. 3 is a schematic illustration of a control unit of the receipt-generating device shown in FIGS. 1 and 2.

### DETAILED DESCRIPTION

The inventive concepts are described with reference to the attached figures, wherein like reference numerals represent like parts and assemblies throughout the several views. The figures are not drawn to scale and are provided merely to illustrate the instant inventive concepts. The figures do not limit the scope of the present disclosure or the appended claims. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

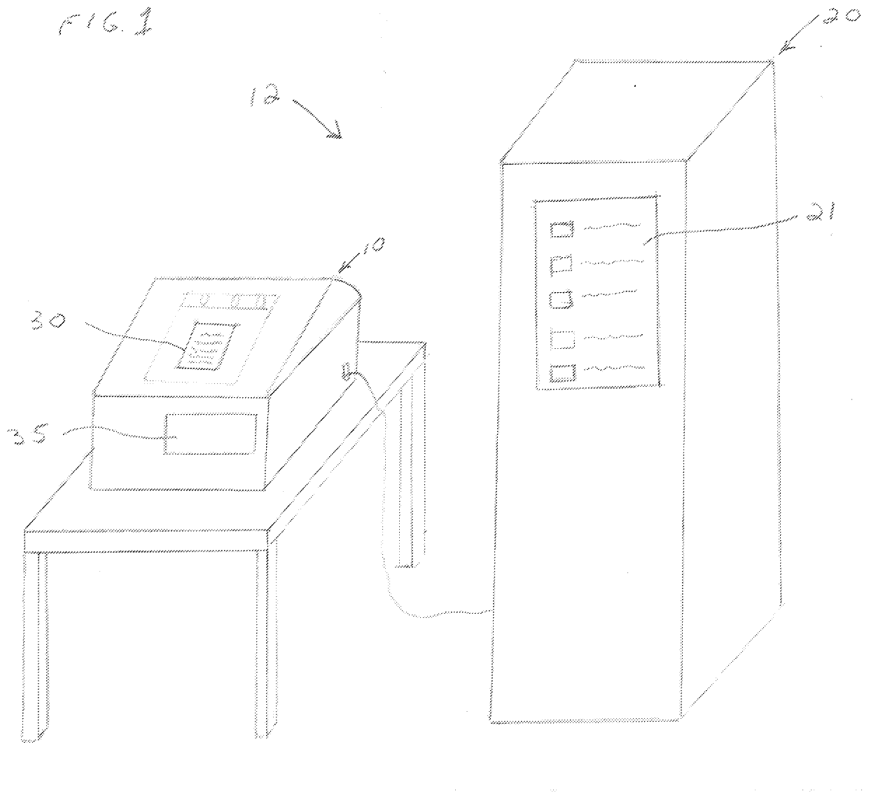

The figures depict a device 10 for generating voting receipts. The device 10 is configured for use with a voting system 12. The voting system 12 comprises a plurality of electronic voting machines 20 by which voters can cast their votes for a particular candidate for elective office, or a particular issue on the ballot. Each electronic voting machine 10 is communicatively coupled to a respective device 10. The device 10 generates a printed record in the form of a receipt 30 that displays the voting choices of the voter, i.e., the names of the candidates for which the voter has cast a vote, and/or the voter's choices on any issues on the ballot. Only one of the devices 10 and one of the voting machines 20 are depicted in FIG. 1, for clarity of illustration.

The electronic voting machine 20 can be, for example, a direct recording electronic machine as depicted in FIG. 1. The electronic voting machine 20 is configured, for example, with a touchscreen display 21 that shows the names of the candidates for elective office and/or the public issues to be voted upon. The voters can cast their votes by pressing the appropriate virtual button on the display 21. Alternative embodiments of the system 10 can be equipped with direct recording electronic machines having other configurations.

In other alternative embodiments, the electronic voting machine 20 can be an optical scanner, or optical scan tabulator, configured to scan a ballot that has been filled out or completed by the voter. The completed ballot indicates the voter's choice of a particular candidate for elective office, and/or the voter's choice in a particular issue listed the ballot. The optical scan tabulator can include a scanning device, and a tabulator communicatively coupled to the scanning device. The tabulator is configured to tabulate the votes for a particular candidate or issue as indicated on the completed ballot, based on the scan of the completed ballot generated by the scanning device. The ballots can be hand-marked by the voter. Alternatively, the marked ballots can be generated by an electronic device, such as a ballot marking device, in response to the voter's input thereto.

The device 10 can be located adjacent to the voting machine 20, so that the voter can retrieve the receipt 30 immediately upon its generation. In applications where the voting machine 20 is enclosed by a screen or other privacy provision, the device 10 can be located within the screened-off area to help ensure that the privacy of the voter is maintained. Typically, one device 10 is associated with one voting machine 20, to help ensure that the actual receipt 30 provided to the voter accurately reflects that particular voter's choices.

Referring to FIG., 2, the device 10 comprises a printing unit 32, a control unit 34 communicatively coupled to the printing device 32, and a display 35 communicatively coupled to the control unit 34. The printing device 32 can be configured as a conventional laser printer comprising, for example, a laser, a fusing unit, a toner and toner cartridge, a drum unit, a transfer belt, and other components that are arranged, and function in a conventional manner. The printing device 32 can be configured as another type of printer, such as a dot matrix printer, an inkjet printer, an LED printer, etc., in alternative embodiments of the device 10.

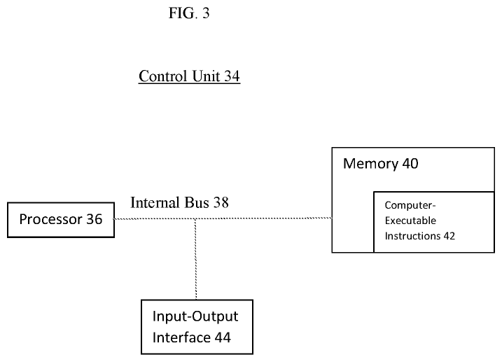

Referring to FIG. 3, the control unit 34 comprises a processor 36, such as a microprocessor; an internal bus 38; a memory 40 communicatively coupled to the processor 36 via the bus; computer-executable instructions 42 stored in the memory 40; and an input-output interface 44 communicatively coupled to the internal bus 38. The control unit 34 can have other configurations in alternative embodiments. Also, the control unit 34 can include additional components, a description of which is not necessary to an understanding of the technology disclosed herein.

The display 35 can be configured to provide an indication of the status of the device 10. For example, the display 35 may display whether the device 10 is on-line and properly communicating with its associated voting machine 20.

Unlike voting machine software, the program logic embedded in the computer-executable instructions 42 can be open source, so that the program logic can be read by anyone. Thus, the program logic is proprietary, but is not hidden or restricted from examination by others.

In addition to the voting choices of the voter, the receipt 30 also can include a time stamp indicating the time and date on which the receipt 30 was generated. Other information can be included on the receipt 30 in alternative embodiments. For example, the receipt 30 can display the voting location, an identifier of the particular voting machine 20 to which the device 10 is connected, etc.

The time stamp is generated by the device 10 independent of the voting machine 20. The time and date upon which the time stamp is based can be set when the control unit 34 of the device 10 is manufactured, and the control unit 34 can be configured so that the running time and date cannot be altered subsequently by an outside source, i.e., by a source other than the manufacturer of the device 10. These features can help to reduce, or virtually eliminate the possibility for the time stamp to be manipulated by a malevolent actor attempting to cause a fraudulent time stamp to be placed on the receipt 30.

The receipt 30 is generated on a real-time or near real-time basis with the casting of the vote, so that the receipt 30 is available to the voter immediately upon completion of the vote-casting process. In alternative embodiments, the device 10 can be configured to receive an input from the voter regarding whether the voter wishes for the receipt 30 to be printed. The voter can be prompted for the input, for example, by a message displayed on the display 35. The user can provide the input, for example, using a virtual button on the display 35 in applications where the display 35 is a touchscreen display. This feature can help to enhance voter privacy by avoiding the printing of a receipt 30 that may be generated without the voter's knowledge and inadvertently left in the device 10 after the voter has left the voting booth.

In addition to generating the receipt 30, the device 10 can be configured to record, in the memory 40 of the control unit 34, the votes cast by the voter exactly as the voting choices appear on the receipt 30, helping to ensure that the information presented to the voter on the receipt 30 is a correct copy of the votes that were cast by the voter. The memory 40 can be configured so that the voting data, once recorded, cannot be deleted or altered by an outside source, i.e., by a source other than the manufacturer of the device 10. The device 10 thus can maintain a separate and permanent record of the votes cast on the voting machine 20. The control unit 34 can be configured to download the stored voting data periodically, to a device (not shown) specifically configured to be temporarily connected to the device 10 and to receive the download upon prompting the device 10.

The device 10 is communicatively coupled to the voting machine 20 or other vote-casting machine by a suitable wired or wireless means. For example, FIG. 1 depicts a wired connection between the device 10 and the voting machine 20. In alternative embodiments, the device 10 can be communicatively coupled to the voting machine 20 by, for example, a Wi-Fi connection. The wired or wireless communication link between the voting machine 20 and the device 10 can be encrypted, to help maintain voter privacy and to prevent hacking. The device 10 is not configured to be communicatively coupled or otherwise connected to any other components or any networks within, or outside of the voting system 12 (including the internet), other than the device configured to receive a download of the voting data stored in the control unit 34. Thus, the device 10 is configured to communicate only over a local network comprising the voting machine 20 and the device specifically configured to receive the download of the voting data.

The device 10 is a separate component from the voting machine 20. The device 10 can be manufactured by, and obtained from a source other than the manufacturer or provider of the voting machine 20, to help ensure the integrity of the device 10 as an accurate and independent record of the votes cast by the voter.

The device 10 receives no direct input from the voter (other than a prompt to generate a receipt 30, in some possible embodiments). The device 10 is not used in any manner to cast or officially record votes, and does not require or alter any method of voting. The device 10 does not control the voting machine 20 in any way, does not provide any inputs to the voting machine 20, and does not interact with the voting machine 20 other than receiving the data indicating the voter's selections, in a specific format recognizable by the device 10. The device 10 does not recognize any other type of inputs, or any commands other than a command to download the voter data stored in the memory 40 of the control unit 34. The device 10 cannot be accessed by the voting machine 20 or any other computing device by any means (other than the device to which the voting data is periodically downloaded).

The device 10 receives no input from the voting machine 20, other than the line of data indicating the voter's selections. The device 10 receives no input from any other component within, or outside of the voting system 12 (other than the device to which the voting data is periodically downloaded). Therefore, there is no way to alter the program logic of the device 10, or the voter data stored therein, and the device 10 is safe from any hacking or intentional manipulation of its data. The sole functions of the device 10 are to print the voter receipt 30 based on the voting selections relayed to the device 10 by the voting machine 20, and to store a record of what was printed.

As noted above, the voting machine 20 is configured to provide an output to the device 10 indicating the votes cast by the voter. The voting machine 20 otherwise is unaffected by its interface with the device 10. The device 10 can be used with any computerized electronic voting machine that provides the appropriate output. In jurisdictions where a state legislature or election authority requires the use of a device, such as the device 10, that provides a voter receipt and/or a supplemental record of the voter's selections, the state legislature or the election authority can specify that the manufacturer of the voting machine 20 make the voting machine 20 compatible with the device 10, i.e., the state legislature or election authority can specify that the voting machine 20 output a line of data, in the format recognizable by the device 10, indicating the choices of the voter as recorded by the voting machine 20.

The user can check the receipt 30 before leaving the voting area, to help ensure that the voter's selections have been recorded correctly by the voting machine 20. In the event the user detects a discrepancy between the user's selections and the selections listed reflected on the receipt 30, the user can notify an election worker before leaving the voting area, so that appropriate corrective action can be taken.

Also, because the device 10 records the voter's selections exactly as the selections appear on the receipt 30, the voter can see, and confirm as accurate the voting data that has been stored in the device 10. Thus, the voting totals documented by and stored in the devices 10 are backed up by the voting public. After an election, the official (legal) vote totals cast on electronic voting machines 20 should match the voting data stored in the corresponding devices 10. If it does not, the public can verify that the votes totals stored in the devices 10 are the correct totals. The public can verify their votes, for example, on a website where the vote totals stored in the devices 10 used in that particular election are published. If significant discrepancies appear between the official vote count and the verified data from the devices 10, an appropriate investigation can be undertaken by the election authority or other governmental actor. Thus, the use of the devices 10, which are physically and functionally independent from the voting machines 20 and maintain an independent and non-alterable record of the voter's selections, can bolster public confidence in the integrity of the final vote count. By comparison, if the receipts 30 were printed by the voting machines 20, the voting public would only have the word of the election authority and/or the voting machine provider that the voting selections on the receipts 30 match what has been tallied by the voting machines 20.

The device 10 also can be used in connection with mail-in voting ballots. In such applications, the receipt 30 can be generated in the above-described manner when the mail-in ballot is scanned by the voting machine 20, and the receipt 30 can be mailed to the voter.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

We claim:

1. A device for generating a voting receipt, the device being configured for use with a voting system comprising an electronic voting machine configured to record voting choices of a voter, the device comprising:
a control unit configured to be communicatively coupled to the electronic voting machine via a local area network only, and to receive from the electronic voting machine data indicating the voting choices of the voter; and
a printing unit communicatively coupled to the control unit and configured to print the voting receipt, wherein the voting receipt indicates the voting choices of the voter.

2. The device of claim 1, wherein the voting receipt further incudes a time stamp indicating the time and date on which the voting choices of the voter were recorded by the electronic voting machine.

3. The device of claim 1, wherein the control unit is configured to be communicatively coupled to the electronic voting machine via an encrypted communication link.

4. The device of claim 1, wherein the control unit comprises a memory, and the control unit is further configured to store in the memory the data indicating the voting choices of the voter.

5. The device of claim 4, wherein the control unit is further configured to download the data indicating the voting choices of the voter to a device configured to receive the data indicating the voting choices of the voter.

6. The device of claim 5, wherein the control unit is further configured to communicate only with the electronic voting machine and the device configured to receive the data indicating the voting choices of the voter.

7. The device of claim 6, wherein the control unit is further configured to receive inputs only from the electronic voting machine and the device configured to receive the data indicating the voting choices of the voter.

8. The device of claim 5, wherein the local area network consists of the voting-device, the electronic voting machine, and the device configured to receive the data indicating the voting choices of the voter.

9. The device of claim 2, wherein the control unit is further configured so that a running time and date upon which the time stamp is based cannot be altered by an outside source.

10. The device of claim 4, wherein the control unit is further configured so that the data indicating the voting choices of the voter cannot be altered or deleted from the memory by an outside source.

11. The device of claim 4, wherein the control unit comprises the memory, a processor communicatively coupled to the memory, and computer-executable instructions stored on the memory and configured to, upon execution by the processor, cause the printing unit to generate the voting receipt.

12. The device of claim 11, wherein the computer-executable instructions are open-source software.

13. A voting system, comprising:
an electronic voting machine configured to record voting choices of a voter; and
a device for generating a voting receipt, comprising:
a control unit communicatively coupled to the electronic voting machine via a local area network only, and configured to receive from the electronic voting machine data indicating the voting choices of the voter; and
a printing unit communicatively coupled to the control unit and configured to generate the voting receipt, wherein the voting receipt indicates the voting choices of the voter.

14. The system of clam 13, wherein the electronic voting machine is one of an optical scanner and a direct recording electronic machine.

15. The system of claim 13, wherein the electronic voting machine and the device for generating voting receipts are provided by different manufacturers.

16. The system of claim 13, wherein the electronic voting machine is configured to generate an output indicting the voting choices of the voter, and the device for generating a voting receipt is configured to generate the voting receipt upon receiving the output of the electronic voting machine.

17. The system of claim 13, wherein the printout further incudes a time stamp indicating the time and date on which the voting choices of the voter were recorded by the electronic voting machine.

18. The system of claim 13, wherein the device for generating a voting receipt is communicatively coupled to the electronic voting machine via an encrypted communication link.

19. The system of claim 13, wherein the printing unit is configured to generate the voting receipt on a real-time or near real-time basis with the recordation of the voting choices of the voter by the electronic voting machine.

20. The system of claim 13, wherein:
the control unit is further configured to download the data indicating the voting choices of the voter to a device configured to receive the data indicating the voting choices of the voter; and
the control unit is further configured to communicate only with the electronic voting machine and the device configured to receive the data indicating the voting choices of the voter.

21. A process for verifying voting totals, comprising:
providing an electronic voting machine configured to record voting choices of a voter;
providing a device configured to generate a receipt indicating the voting choices of the voter as cast on the electronic voting machine, and further configured to store data indicating the voting choices of the voter as cast on the voting machine, the device being physically and functionally independent of the electronic voting machine;
providing the receipt to the user; and
publishing the data indicating the voting choices of the voter as stored in the device in a medium accessible to the voter.
